(19) United States
(12) Patent Application Publication
(10) Pub. No.: US 2006/0265091 A1
(43) Pub. Date: Nov. 23, 2006

(54) Audio entertainment system for storing and playing audio information

(76) Inventor: Bruce Mihura, Austin, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/404,673

(22) Filed: Apr. 14, 2006

Related U.S. Application Data
(62) Division of application No. 09/134,799, filed on Aug. 14, 1998.

(51) Int. Cl. G06F 17/00

(52) U.S. Cl. 700/94

(57) ABSTRACT

A customized music recording, selection and playback system providing a convenient means for storing hundreds to thousands of songs on a single system, which provides immediate access to any of the songs in a convenient, easy to operate manner. This audio entertainment system can store audio sound recordings, or even segments of a sound recording selectively, not merely store collections of existing media. The system can use any audio source, digital or analog, for the audio content. The system replaces boxes of phonograph records, boxes of cassette tapes, cases of CDs, and a plurality of musical pieces (or “songs”), by storing all audio information in one chassis. The system is continuously reconfigurable; songs can be added or removed at any time. The system efficiently stores audio information, using a digital audio compression system that preserves near compact disc quality but achieves a large reduction in the size of the stored digital audio information. The compression system is particularly effective for stereo recordings, i.e. two channels of audio corresponding to the conventional dual microphones used in music recording. Thus, many more songs could be stored on the system at a given time.

### FIELD OF THE INVENTION

This invention is in the field of consumer electronics, specifically the reproduction of high quality audio recordings, typically music.

### BACKGROUND OF THE INVENTION

High quality sound recordings became available to the consumer with the advent of the Compact Disc, or “CD”, which uses digital recording techniques to record the audio information. Earlier systems were predominantly analog, including phonograph records and magnetic tape cassettes, and were plagued with problems of physical media damage such as scratches or warping, as well as sensitivity to dust and dirt in the environment or on the playback system. With the use of laser-based digital recording, as with Compact Discs, many of these problems are avoided.

Although the quality has improved with digital recording of analog audio information, to a, large measure the convenience of access to selected sound recordings is much the same as before. An individual CD typically contains no more than two dozen songs, so the user of such systems frequently needs to change media. In the earlier era, this was solved with phonograph records by the use of robotic media changers, such as “jukeboxes”, as well as devices that could play a preselected series or “stack” of records.

With the advent of CDs, similar devices have been adopted to physically select a particular CD out of a selection of CD media stored in the device. Small units have 5 or 6 CDs in a cartridge; large units may have dozens or more in a device which physically operates very much like the jukebox of the phonograph record era. U.S. Pat. No. 5,559,776 discloses a disk recording medium playback system where the plurality of disks are stored in a magazine.

The existing media is difficult to customize to the user's desired content. Phonograph records and CDs cannot be erased and re-recorded. Cassette tape recordings can be erased, but it is impractical to replace songs other than at the end of the recording; furthermore, locating a specific song requires scanning past all prior songs to locate it.

Digital recordings on compact disc require large amounts of data to store the recordings. Digital audio is frequently sampled at 44.1 kHz with 16 bits per sample, thus requiring over 700,000 bits per channel per second of recorded audio information. For stereo, this is 1.4 million bits per second. This is one of the reasons that compact discs are limited in their ability to store audio information.

Digital compression techniques are now available which are capable of data reduction by large factors. For example, U.S. Pat. No. 5,579,430 encodes CD-quality data at 2 bits per sample, and FM-radio quality data at 1.5 bits per sample. This corresponds to compression ratios (from 16 bits/sample) of 8:1 and 12:1, respectively. The use of “perceptual coding” which recognizes the acoustic characteristics of the human ear, enables improved quality, or better compression, or both, as illustrated for example in U.S. Pat. Nos. 5,040,217 and 5,717,764. As judged in professional listening tests in conjunction with the MPEG standards development, the combination of these techniques achieves approximate CD-quality at 1.5 bits per sample.

It is known in the art to utilize compression to reduce the storage requirements on disk. For example, U.S. Pat. No. 5,224,087 discloses the recording of compressed digitized information to an optical disc.

There have been a number of so-called “multimedia” programs built on computer systems. Many of these utilize compression, especially for video. Real-time audio compression has been accomplished by means of a second processor, which may be a digital signal processor. However, these systems require a computer, including keyboard, mouse, monitor, operating system, and the like. Thus, these systems are not effective for the non-computer user, and are not aesthetically and operationally compatible with typical home entertainment complexes. Most home or office computers today do not have a real time operating system, meaning that any jukebox program that could be written would be susceptible to unexpected pauses of arbitrary duration. In addition, they have not provided an effective “audio jukebox” capability—i.e., the ability to store, index, retrieve and play a large number of audio recordings.

U.S. Pat. No. 5,481,509 discloses a system for use in public areas such as bars and dancehalls. This provides a money-operated computer-based “jukebox” where the audio/visual information is stored on pre-recorded removable hard disks. Two computers are used for the play-only jukebox; these computers may be connected via a network. Real-time inputs are limited to a microphone (for karaoke sing-along) and a video camera. These real-time inputs are not stored on the hard disk, however, but rather are immediately output to the corresponding audio and video output devices or stored on a VCR tape. A third computer, remotely located from the jukeboxes, is in effect the manufacturing system for the pre-recorded removable hard disks. On this third computer, audio inputs are provided for CD, VCR and laser disk. No real-time capture is provided, e.g. from FM radio. It is assumed that CD and VCR inputs are compressed at standard input rates; faster-than-real-time recording is not disclosed. It appears that the key purpose of the removability of the hard disks is to be able to physically remove them from the recording (third) computer at the central location and carry them to the jukebox at the dancehall. Consequently, this system is, in effect, comparable to compact disc except the media is a hard disk (or other similar mass storage device, magnetic or otherwise). Although it eliminates a number of problems for the commercial user, it does not provide a single, compact, easy-to-use, record and playback system for the home entertainment user. In addition, this system provides both audio and video information on the disk; since video information takes vastly more disk space, even when highly compressed, the system will be limited in its capability to store large number of audio recordings on a hard disk. Other features which make this system more suited to commercial use than home or portable use are the integrated money input, the large size, the separate physical components, the video screen and camera, the amplifier, and the speakers. The system provides a sorted list by type of music, but no indexed database access that would be necessary for organizing a large collection of diverse music.

Thus, an object of this invention is to provide an audio entertainment system that provides instant access to a large collection of audio recordings. It is important that the packaging has a size and appearance which approximates a size of standard audio equipment, and the price be no more than a few thousand dollars.

It is an object of the invention to provide so-called multimedia capabilities, but without the user interface, training and support complexities of even the easiest-to-use computer system.

It is an object of the invention to replace a number of devices, each customized for a particular type of media (e.g. phonograph records, cassette tapes, reel-to-reel tape, CDs, FM radio, computerized MPEG files, Internet access) with a single system.

It is an object of the invention to utilize industry standard compressed digital audio recording formats so as to facilitate the transfer of audio recordings. One such format is described in the MPEG standard, ISO 11172-3.

Another object of this invention is to store a large number of audio recordings very efficiently by means of a quality-preserving digital compression system. It is particularly important to preserve audio quality for multi-channel music recordings, usually two to five channels of audio corresponding to a single recording. It is of particular import to preserve quality for two-channel stereo recordings. Multi-channel recordings with more than two channels, such as from DVD, could be used in this invention as well.

An object of the invention is to facilitate the rapid loading of the storage system from a variety of audio input sources.

Another object of the invention is to provide a convenient system for selecting music to be played.

### SUMMARY OF THE INVENTION

This invention provides a system for storing hundreds to thousands of songs on a single audio entertainment system, which provides immediate access to any of the songs in a convenient, easy to operate manner. The system can store audio sound recordings selectively, not just collections of existing media. The system can use any audio source, digital or analog, for the audio content. The system replaces boxes of phonograph records, boxes of cassette tapes, and cases of CDs by storing all audio information in one chassis. The crux of the invention is that audio information is never removed and replaced on a repeated basis; the storage capacity will be sufficient to hold most entire musical collections. The system efficiently stores audio information, using a digital audio compression system that preserves near compact disc quality but achieves a large reduction in the size of the stored digital audio information. The compression system is particularly effective for stereo recordings, i.e. two channels of audio corresponding to the conventional dual microphones used in music recording. Thus, many more songs could be stored on the system at a given time.

The system comprises one or more analog and digital audio input and output ports, a processing unit comprised in the chassis which may utilize an auxiliary digital signal processor, a non-removable, non-volatile random-access storage system such as a magnetic disk, a user interface system, and control software in the processing unit to operate the system. A key concept to this system (although not obvious) is that the storage system is virtually never to be removed, and is substantially permanently affixed inside the chassis, so as to greatly reduce the need to ever handle physical media.

### BRIEF DESCRIPTION OF THE DRAWINGS

FIG. 1 is a drawing of the audio entertainment chassis, showing controls and connections on the front panel of the chassis.

FIG. 2 is a drawing of the rear panel of the chassis, showing the several interface connections.

FIG. 3 is a schematic drawing of the hardware components of the audio entertainment system.

FIG. 4 is one possible physical layout of the major processing elements internal to the chassis of the audio entertainment system.

FIG. 5 is a block diagram showing the flow of audio information in the system during audio input processing.

FIG. 6 is a block diagram showing the flow of audio information in the system during audio output processing.

FIG. 7 is a diagram of the structure of the index database for selective access to the system.

FIG. 8 is a drawing of the wireless remote control device for operating the system.

FIG. 9 is a flow chart describing one possible means for entering CD songs into the system.

### DESCRIPTION OF THE PREFERRED EMBODIMENT

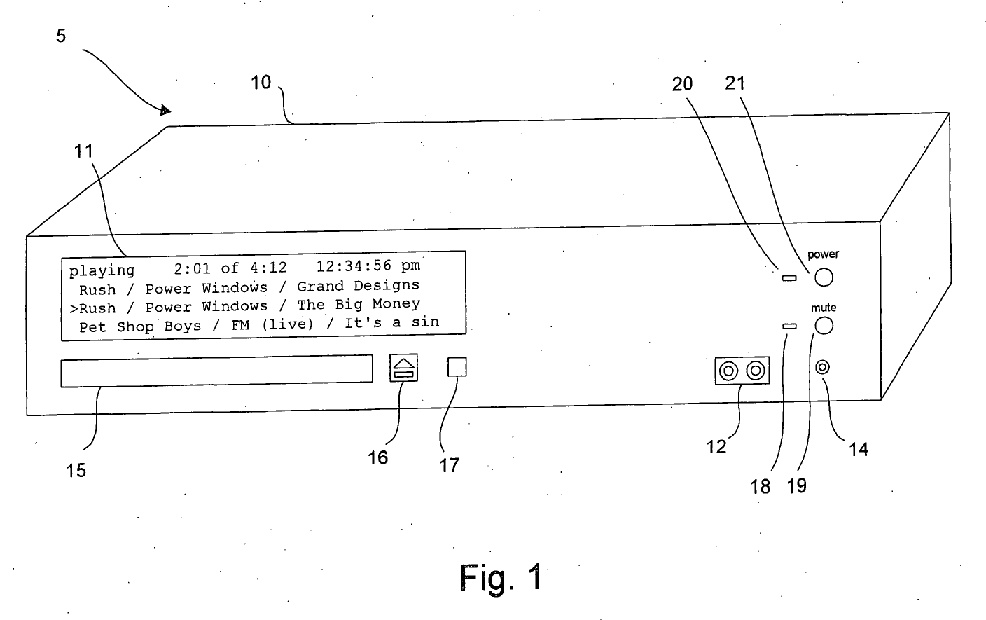

Referring now to FIG. 1, the audio entertainment system 5 is housed in a rectangular shaped chassis of the typical size and appearance found in home entertainment centers. For example, it may have a width of about 17 inches, a depth of about 10 inches and a height of about 6 inches. The front panel is shown having connections 12 for analog audio input of the type commonly known as “RCA jacks”. Alphanumeric display 11 is used to indicate the status of the system, and to provide numerical and textual information about recordings contained in the system which may be selected, or are about to be played. It may conveniently be an alphanumeric display of 4 lines, each containing 40 characters. As an example of content, it could display as follows:
>playing<2:01 of 4:12 12:34:56 pm
Rush/Power Windows/Grand Designs
>Rush/Power Windows/The Big Money
Pet Shop Boys/FM (live)/It's a sin
   the top line indicating the status and information about the currently playing song, and the remaining three lines containing information about other songs to be played or which could be played. Display 11 may be, for example, the DMC-40457NY-LY-B by Optrex America, Inc., Duluth, Ga.

Headphone jack 14 is provided to allow for the connection of standard stereo headphones (tiny speakers placed close to or in the ear). CD reading system 15, with associated CD eject button 16 provides the ability to load CD audio recordings directly into the system, without external connections. The built-in CD reading system has a direct digital interface to the CD, so as to preserve exact digital representation of the audio information recorded on the CD, thus avoiding a conversion from digital to audio and back again to digital. This CD reading system is advantageously able to load data at faster than real-time. This may be, for example, the Plextor model PX-12TSi audio CD reader, from Plextor Corp. of Miami, Fla., which currently can read audio CDs at speeds more than four times faster than real time.

Infrared (or other wireless) sensor 17 is a plastic window which is relatively transparent to infrared light, behind which is the photodetector used, to receive infrared signals from the wireless remote control device. Alternatively, this could be an RF antenna if radio communications were used.

Power switch 21 is used to turn the AC electrical power to the system on and off. Light emitting diode 20 indicates the power status by glowing when power is on. Mute button 19 causes the system to mute its audio output; mute status light 18 indicates that the system is in the muted state; pressing the mute button again returns it to audible state.

Chassis 10 contains the electrical components to operate the audio entertainment system, including the control processor, the digital compression and decompression systems, which may use one or more auxiliary DSP processors, analog and digital audio input and audio output circuitry, and connections to the various controls and connection ports of the system. In particular, the chassis contains hard drive, herein defined as any non-volatile re-writable random-access storage system, which may be magnetic, optical, magneto-optical, holographic, electrical (such as silicon), etc.

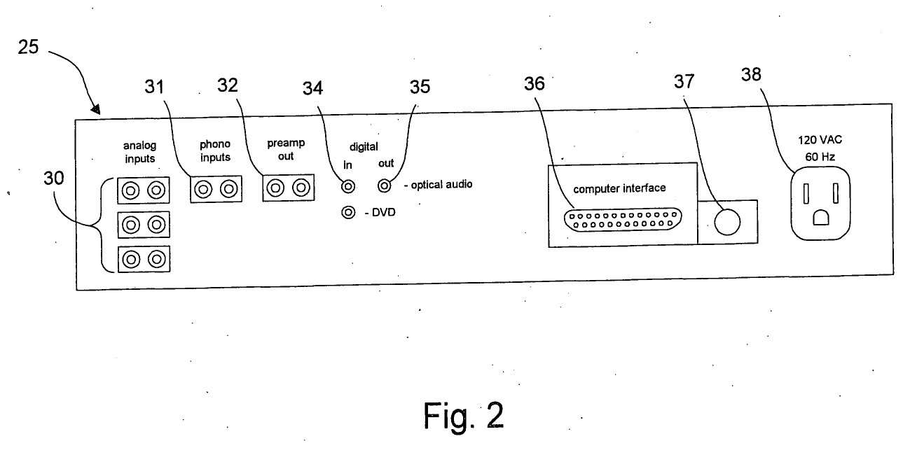

Turning now to FIG. 2, the rear panel 25 of the audio chassis is presented. Analog inputs 30 are provided for standard audio equipment; phonograph inputs 31 are for connection to a phonograph input. Analog audio outputs 32 are for interfacing to standard audio equipment, such as an amplifier which would ultimately connect to speakers. Digital inputs 34 are provided for devices which supply audio data in digital form. Similarly, digital output 35 is provided for interfacing output audio information to devices which accept it in digital form. This may be in the form of a fiber-optic connection. Optional computer interface 36 is shown as a DB-25 connector but may be of a variety of connectors, electrical and protocols, such as serial, parallel, SCSI, Ethernet, USB (Universal Serial Bus), IEEE 1394, or other desired digital computer interface. Optional port 37 allows for the connection of a standard PC keyboard to the system, for rapid entry of alphanumeric data, particularly useful when setting up the system for the first time, or when loading new audio information. The computer is not only operable to present a user interface which is useable in controlling the user interface control system, but can act as a conduit for audio information either over a network or into and out of the computer itself. Power connector 38 is used to connect to AC power.

The number, exact connector type, and layout of the rear panel can have a variety of forms to suit various applications. It may also be convenient in some instances to have more, or fewer of these connections on the front of the chassis.

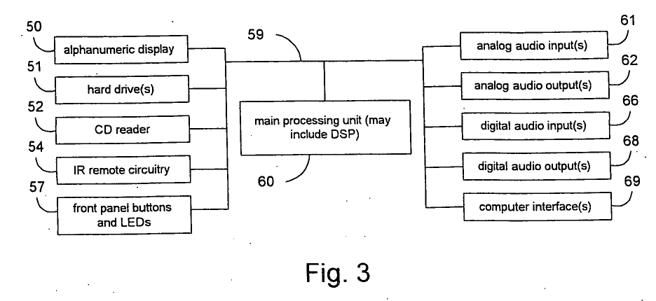

A simplified block diagram of the internal operation of the system is shown in FIG. 3. Starting in the center of the figure is data bus 59 which is used to allow communication amongst the various components. Although shown as a single data bus, it may be composed of a set of busses which can be switched together in various ways, thus allowing input, output and processing flexibility. Main processing unit comprised in the chassis 60 contains the control logic and computational elements of the system, and may include a CPU, microcontroller, DSP chip, programmable gate array logic, etc. The main processing unit comprised in the chassis may be, for example a 486 chip from Intel Corp. of Santa Clara, Calif. The DSP chip, if not implemented in the main processing unit, may be for example, a TI 320C30 from Texas Instruments of Dallas, Tex. The analog output can be done with either a digital-to-analog chip, or any standard PC “sound card” of sufficient fidelity (approximately CD quality), such as the AudioPC™ S5016 from ENSONIQ, Malvern, Pa. This card also can perform the analog input function, as could an analog-to-digital chip. Control and switching logic are of standard design, with care to assure that analog switching components do not compromise signal quality. Item 50 is the interface to the alphanumeric display 11 shown on the front panel in FIG. 1. Hard drive(s) 51 are used to store audio recordings in compressed form, indexes and relational database information to provide access to them, and buffer real-time data, which may be in compressed or uncompressed form. In addition, disk space management information will be stored and maintained such as the location of the various files, bad block list, and free block list.

CD reading system 52 contains the electrical components to read audio compact discs in digital form; the front opening allowing the insertion of CDs into this chassis is shown in FIG. 1 as item 15. Circuitry for receiving remote control signals 54 which may be of the infrared or radio transmission form is connected so as to permit remote control of the system. Front panel buttons and indicator light-emitting-diodes (LEDs) 57 are also connected to the system.

To the right side of FIG. 3 are shown the various input and output interfaces, not all of which may be present. Analog audio input(s) 61 may come from a microphone or various audio units, such as CD players, tape payers, etc. Analog audio output(s) 62 may connect to an amplifier, headphones, or a separate recording unit. Digital audio input(s) 66, perhaps optical, such as from a microphone or various audio units, such as CD players, tape players, etc. Digital audio output(s) 68, perhaps optical, may go to an amplifier, headphones, or a separate recording unit. An optional computer interface 69 will not only allow connection to a computer, but also downloading and uploading digital audio information to a local computer and to any other place connected to the computer, including local and wide area networks, such as the Internet.

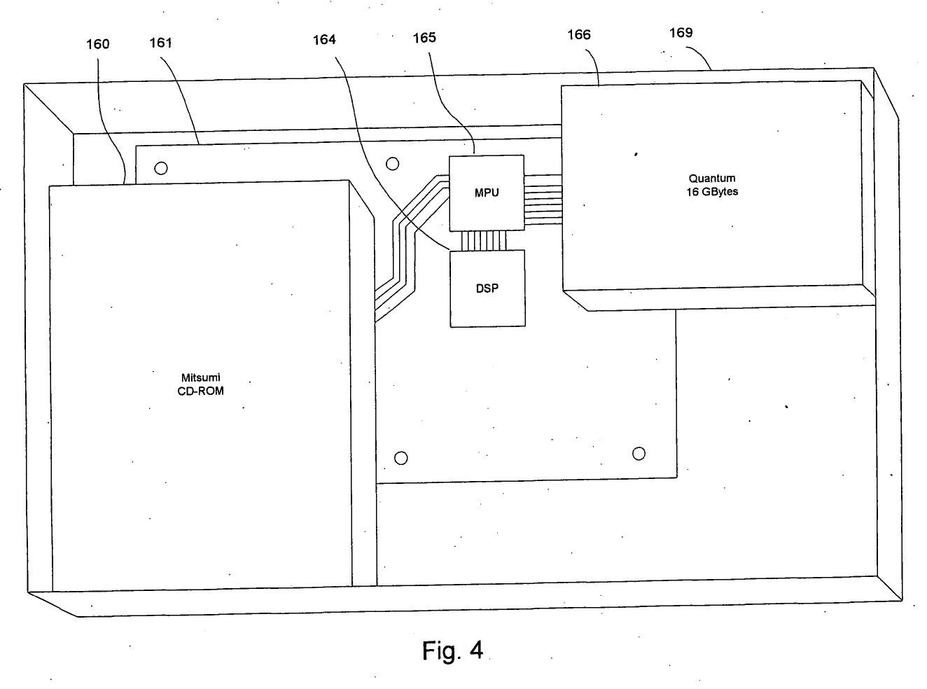

FIG. 4 is one possible layout of the major elements contained inside the audio entertainment chassis. Compact Disc reading system 160 is used to load audio data contained on CDs into the system. It should operate at least at standard audio rate reading, in accordance with the Red Book standard, but it may also be considerably faster. The Plextor model PX-12TSi audio CD reader, from Plextor Corp. of Miami, Fla., can read audio CDs at speeds more than four times faster than real time. Circuit board 161 is used to mount the smaller electrical components, and provides the wiring busses to connect them. Front and rear panel connectors may be mounted directly on the circuit board, as known in the art. Mounted on the circuit board are processing unit 164 which may be an Intel 486 chip for example; optional DSP chip 165 is shown mounted on the circuit board as well. A major subsystem inside the chassis is the non-volatile random-access storage system 166, such as a hard disk drive. Item 169 is a cutaway view of the outer shell of the chassis, as would be viewed from above.

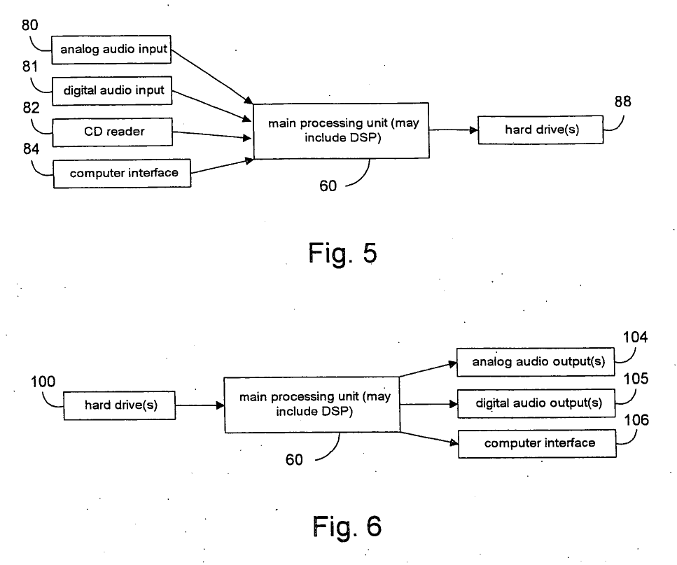

Audio input processing is detailed in FIG. 5. Audio may be taken from an analog input 80, digital input 81, built-in digital CD reading system 82 (same as 52) or from a digital bit or byte stream from a computer interface 84 (corresponds to 69 in FIG. 3). The audio information is read, compressed if necessary, and stored to hard disk(s) 88 by the main processing unit 60, which may include one or more digital signal processors.

Audio output processing is detailed in FIG. 6. Audio from hard disk(s) 100 is read by the main processing unit 60, decompressed, and output to an analog output 104, digital output 105, or computer interface 106.

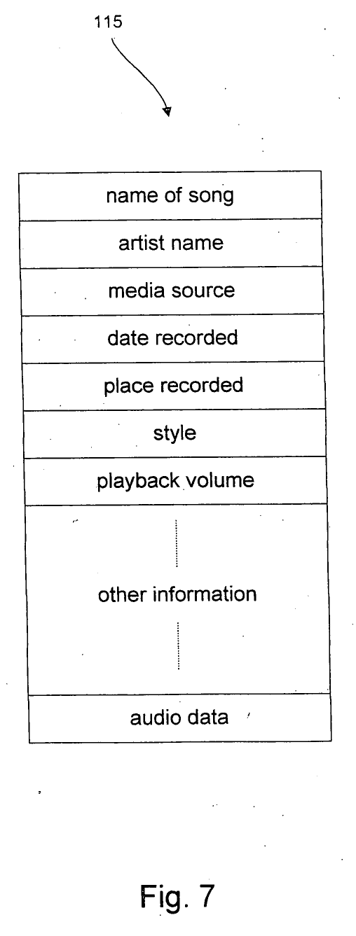

The data content and indexing fields are shown in FIG. 7. In its simplest form, it is a sophisticated contents directory or play list 115, wherein indexes are provided for one or more of these fields, for example allowing immediate display of all songs for which “artist name” is “Prince”. Any number or type of common characteristics could be used to select a set of songs. Alternatively, one or more relational tables may be built to allow more complex queries as is typical of relational databases, as is known in the art.

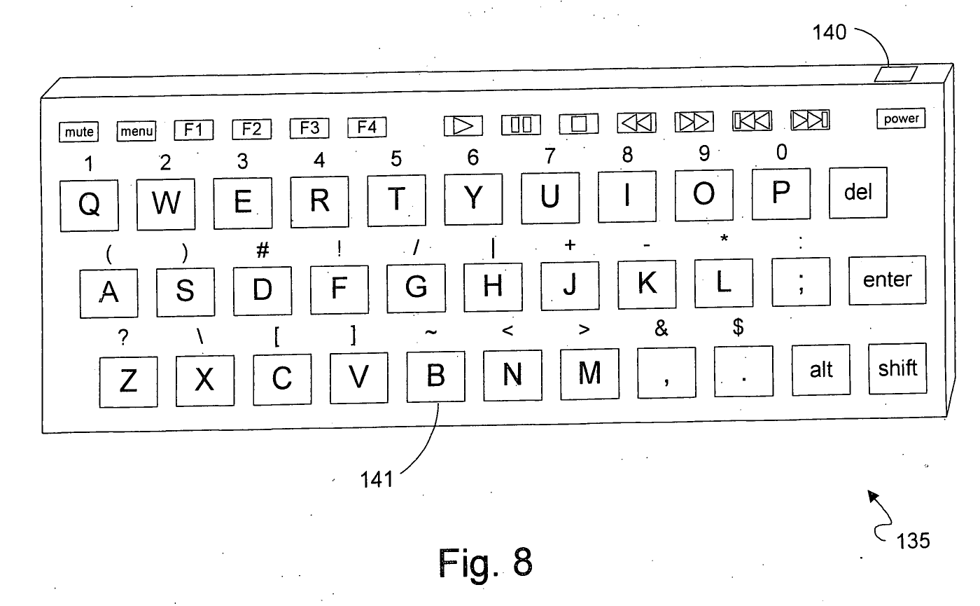

Remote control device 135 is shown in FIG. 8. This small, hand-held device is configured with a standard typewriter-format “QWERTY” keyboard layout 141, to facilitate usage with alphabetic information. Numeric data can also be entered, as shown. Standard audio controls for play, stop, rewind and so forth are in the upper right section of the device. Special functions can be programmed into function keys F1, F2, F3, F4 as is known in the art, for example F1 might play background music, F2 jazz, and so forth. Optical transmitter 140 is used to transmit commands to the sensor located on the main chassis. Alternatively, a radio-frequency transmission could be used.

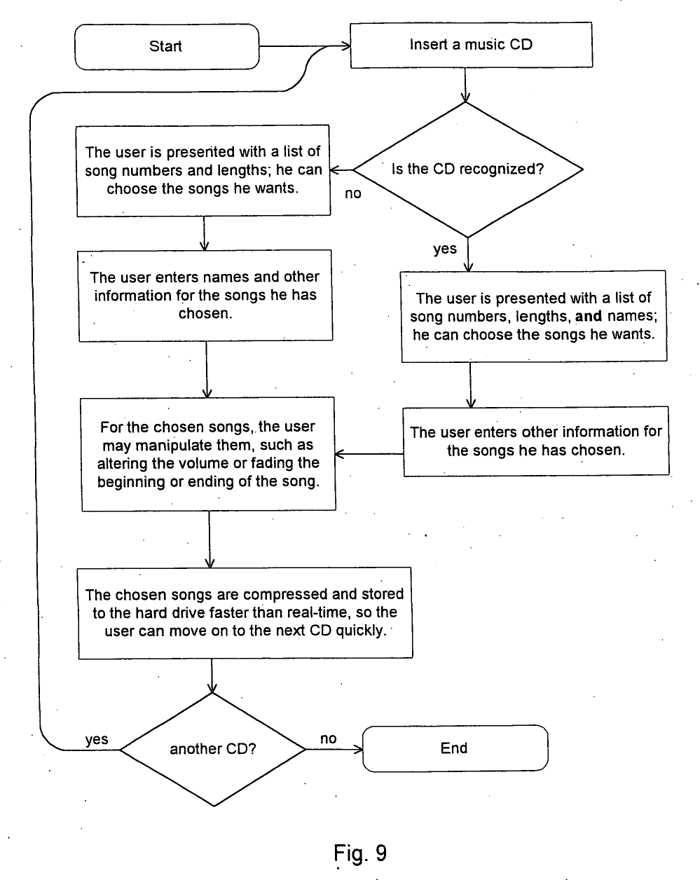

A flow chart describing one possible means for entering CD songs into the system is shown in FIG. 9. A CD is just one of the many possible ways to input music, which has the advantage never leaving digital form.

Items which optimize this system for home or even portable use include the CD reading system, the audio inputs and outputs which are compatible with home audio equipment, the mute button, the remote, and the physical size and appearance. The system has a size and appearance which approximates a size of standard audio equipment.

The system uses standard MPEG formats for storage of compressed digital audio. One such format is described in ISO 11172-3. This facilitates electronic commerce shopping for audio products over such wide-area-networks as the Internet. Even dial-up modem connections of the “56K” variety can send a 3-minute audio recording at 12:1 compression in slightly over 6 minutes. Rather than driving to the store to buy a new CD, you can pick up the song you want right over the Internet. With higher speed data communications systems such as ISDN (Integrated Services Digital Network), DSL (digital subscriber loop), satellite link, cable modems, and fiber to the curb, etc. this access will improve. But it is an important to utilize a standard format to avoid the quality reduction problems caused by iterative digital compression and decompression.

The digital signal processor (DSP) may be used to facilitate the rapid loading of audio recordings onto the storage system. Except for pre-compressed audio, the audio information will need to be compressed, which is a computationally intensive operation. For real-time recording, e.g. of a broadcast audio signal, it is mandatory that the system be able to compress audio at least real-time rates. Although some buffering can be provided, a length real-time broadcast (a Verdi Opera, for example) may well exceed the system's ability to store uncompressed data. With real-time digital compression (or faster), only the compressed data need be stored in the storage system.

Digital signal processing power would allow digital compression and decompression (audio playing) simultaneously. Since this invention is designed to be the primary audio unit, it would be beneficial to always have the ability to play music, even during compression.

Another use of the digital signal processor (DSP) is in the loading of data from non-compressed digital sources, of which compact discs are an important example. To be convenient to the user, this process should go as quickly as possible. The user may select which songs from the CD (or other source) to load, thus the system does not even need to process non-selected songs, except to perhaps skip past them on media such as tape which can only be processed sequentially. For CDs, only those songs selected are read into the system. For media where a number of songs are selected, it is desirable, especially for CDs, to be able to process them at faster than real-time. The Plextor audio CD reader, for example, has a model which can operate at what is knows as “12×”. This can read 2 channels (for stereo) at least four times as fast as real-time. Without a fast computational system, it would be impossible to read, compress, and store audio data at over four times real-time, which would be desirable for the user. It is expected that CD reading devices will shortly operate at considerably faster speeds, for example 20× or even 24×. A fast DSP with efficiently programmed compression algorithms is desired to utilize this capability.

As an example to illustrate the effectiveness of the system, a user with 1000 items of various media could store audio recordings as follows. For convenience of presentation, we will talk of CDs, but understand that they may be any combination of phonograph records, CDs, tape cassettes or other forms of audio information, including real-time sources. Of the 1000 items, select 20 3-minute songs from the first 100, 10 from the next 500, and 2 from the last 400. This is a total of 200+5000+800, or 6000 3-minute songs. This is 18,000 minutes or 1,080,000 seconds. Assuming stereo recordings at 44.1 kHz, 1.41 megabits are required per second of audio data; with a compression of 12:1, this would reduce to 117.6 kilobits or 14.7 kBytes per second of data. The entire data would require approximately 16 GB (gigabytes or billions of bytes) of storage.

The physical size, appearance, packaging, ease of use, and feature set of the system is important. In particular, the user interface system should be compatible with that which is commonly found in high quality audio gear. It comprises user inputs, such as buttons, knobs, touchscreen inputs, and switches, as well as user output displays, capable of displaying information to the user. Another item of import, and frequently ignored by computer-based multimedia systems, is the need for acoustic noise shielding from the noise-generating components of the system. The objective should be to make the system as a whole acoustically quiet. Rotating media drives and cooling fans should be selected for their quietness as well as their large capacity, and the entire chassis acoustically shielded as well as practicable.

An optional addition to the user interface is the ability of voice control, by using voice commands as input to the system. Speech recognition technology has recently evolved to the point of making this practical. Any input which could be done with the remote could also, perhaps more easily, be done with voice commands.

A remote control device is provided to make operating the system convenient for the home user. This remote comprises a set of buttons that allow selection of individual or predetermined groups of music, including random play. It will allow for a full alphabet as well as numeric input. It may also be used to control the addition of new music to the system from one or more of the audio inputs. The remote, although not shown in the figures, could also be used to display output from the system in addition to or instead of the alphanumeric display on the chassis.

The ability to capture real-time audio will now be described. To facilitate this operation, it may be desirable to have the system continually monitor, compress, and record up to a few minutes of musical data at all times. The user interface could be used to perform a variety of related tasks. By continuously storing this previously received audio input, this would allow a user, for example, to recognize a song that he or she would like to record, and initiate recording without losing the first few seconds of the song. After the song is completed and recording stopped, it would be desirable to review and manipulate the audio information, then save the new version to the storage system. For example, the song can be reviewed to determine the exact portion of the prerecorded audio information to be stored, as well as the precise determination of the end of the recording. In addition, it may be desirable to add a fade-in and fade-out at the beginning and end of the song, respectively, to avoid sharp transitions. It may be desirable to record radio broadcasts, so an AM/FM radio tuner could be integrated into the unit.

The system can be pre-programmed to record real-time audio information at future, scheduled dates and times as is typically provided on videocassette recorders.

A master song directory stores characteristic information about each song, such as composer, orchestra, soloist as well as the location of the music itself. For example, the disk may be segmented into a number of equal sized blocks, e.g. 4096 bytes each, and a linked list of such blocks can be used to access the file. This linked list, and other information necessary to managing the allocation of the disk system, such as the free block list, as well as the location of the various indexes, can be stored in a physical disk allocation record, also stored on disk.

A database of information is provided to enable rapid access to desired audio information from a variety of points of view. In its simplest form, this is simply contents directory, or a set of indexes, followed by a list of the songs pertaining to that index. Alternatively, a network or relational database may be used to provide many-to-many access for COMPOSER (e.g. Mozart), ORCHESTRA (e.g., London Symphony, Starland Vocal Band), CONDUCTOR (e.g., Neville Mariner), SOLOIST (e.g., Jean-Pierre Rampal, John Denver), CLASS OF MUSIC (rock, jazz, orchestral, 17^{th} century strings, and the like), DISTRIBUTOR (e.g., MCA records, FM radio station KMFA). To facilitate the use with popular music, indexes and/or relational table can be made with terms familiar to that genre, such as SONGWRITER, ARTIST or PERFORMER, and BACKUP GROUP. In fact, any set of indexes or relational table may be used as desired by the user, for whatever purpose.

This system can be used advantageously in conjunction with a centralized library of pre-compressed audio recordings. The network input (and output) can be a local area network such as Ethernet, or a wide area network such as the Internet. Due to the use of pre-compressed digital audio, using standards which the system can play without re-processing, audio recordings can be downloaded from the central library server to the system in near-real-time. With 56K modems, for example, with effective data rates of over 50,000 bits per second, the download takes approximately twice real-time. With faster communications systems, for example DSL (digital subscriber loop), songs can be downloaded in just a few seconds. To illustrate this, assume a DSL link operating at 1 megabit per second. 16-bit digital audio compressed 12:1 takes 117.6 kbits per second of music. This is 8.5 times faster than real-time, so a 3-minute song would take only 21 seconds to download.

Even with ordinary telephone lines operating with 56K modems, remote distribution of music via networks is quite practical. Purchasing could easily be performed over networks, as well. And there is tremendous benefit in being able to provide the user the ability to acquire the songs he wants immediately.

It is important that the data on the central library be compressed, so as to speed up the transmission process by, for example, a factor of 12. However, it is desirable that it be digitally compressed in a format that can be directly used by the playback system, so that an extra compress/decompress step is avoided. Since these high compression-ratio audio compression techniques are not lossless, each compression step degrades the sound quality. And two stages using a different technique can produce substantial degradation, even if each technique when used alone may be quite good.

1. An audio entertainment system for storing and outputting audio information, comprising:
a chassis for housing electrical components, wherein the chassis comprises a front side;
at least one audio output comprised in or located on the chassis, wherein the at least one audio output is operable to generate signals;
a non-volatile random-access storage system comprised in the chassis for storing a plurality of compressed musical pieces, wherein each of the plurality of compressed musical pieces comprises compressed audio information, wherein the non-volatile random-access storage system is substantially permanently affixed inside the chassis and is not readily removable from the chassis;
a decompression system coupled to the non-volatile random-access storage system and to the at least one audio output, wherein the decompression system is operable to receive the compressed audio information from the non-volatile random-access storage system and is further operable to decompress the compressed audio information to produce uncompressed audio information, wherein the digital decompression system provides the uncompressed audio information to the at least one audio output; and
a user interface system for controlling the audio entertainment system, wherein the user interface system includes a display positioned on the front side of the chassis, wherein the display is operable to display status information of the system and information regarding the plurality of compressed musical pieces stored in the storage system;
wherein the audio entertainment system has an appearance which approximates standard audio equipment.

2. The audio entertainment system of claim 1, wherein each of a subset of the plurality of compressed musical pieces comprises a MPEG format.

3. The audio entertainment system of claim 1, wherein the non-volatile random-access storage system is further operable to store a plurality of directories, wherein each of the plurality of directories associates a selected subset of the plurality of compressed musical pieces according to common characteristics of the selected subset of the plurality of compressed musical pieces;
wherein the user interface control system is further operable to use the plurality of directories to selectively access one or more of the plurality of compressed musical pieces.

4. The audio entertainment system of claim 3, wherein the user interface control system is further operable to display list information for a directory of the plurality of directories, wherein the list information indicates one or more of the selected subset of the plurality of compressed musical pieces.

5. The audio entertainment system of claim 1, further comprising:
a media reading system comprised in the chassis, wherein the media reading system is operable to receive audio media, wherein the audio media comprises audio information, wherein the media reading system is operable to read at least a portion of the audio information from the audio media;
a digital compression system coupled to the media reading system and coupled to the non-volatile random-access storage system, wherein the digital compression system is operable to receive the at least a portion of the audio information from the audio media, wherein the digital compression system is further operable to produce compressed audio information from the at least a portion of the audio information from the audio media, wherein the digital compression system is further operable to transmit the compressed audio information to the non-volatile random-access storage system, wherein the non-volatile random-access storage system is further operable to store the compressed audio information.

6. The audio entertainment system of claim 5, wherein, in said producing the compressed audio information from the at least a portion of the audio information from the audio media, the digital compression system is further operable to produce the compressed audio information in a MPEG format.

7. The audio entertainment system of claim 5, wherein the non-volatile random-access storage system is further operable to store a plurality of directories, wherein each of the plurality of directories associates a selected subset of the plurality of compressed musical pieces according to common characteristics of the selected subset of the plurality of compressed musical pieces;
wherein the user interface control system uses the contents directory to selectively access ones of the plurality of musical pieces;
wherein the non-volatile random-access storage system stores a database directory comprising information regarding contents of existing audio media;
wherein the user interface control system is operable to use the database directory to recognize audio media from the media reading system;
wherein the user interface control system is further operable to automatically add compressed audio information to the directory from the database directory in response to recognizing an audio media.

8. The audio entertainment system of claim 1, wherein the at least one audio input includes a network input adapted for receiving input audio information from a network.

9. The audio entertainment system of claim 8, further comprising:
a digital compression system coupled to the network input and coupled to the non-volatile random-access storage system, wherein the digital compression system is operable to receive at least a portion of the audio information from the input audio information from the network, wherein the digital compression system is further operable to produce compressed audio information from the at least a portion of the audio information from the input audio information from the network, wherein the digital compression system is further operable to transmit the compressed audio information to the non-volatile random-access storage system, wherein the non-volatile random-access storage system is further operable to store the compressed audio information.

10. The audio entertainment system of claim 9, wherein, in said producing the compressed audio information from the at least a portion of the audio information from the audio media, the digital compression system is further operable to produce the compressed audio information in a MPEG format.

11. The audio entertainment system of claim 8, wherein the user interface system is adapted to receive user input comprising selection information for selecting one or more musical pieces over the network;
wherein the user interface control system is operable to receive the user input comprising selection information and control the network input and the non-volatile random-access storage system to receive the one or more musical pieces and store the one or more musical pieces on the non-volatile random-access storage system.

12. The audio entertainment system of claim 8, wherein the user interface system is adapted to receive user input comprising purchasing information for purchasing one or more musical pieces over the network;
wherein the user interface control system is operable to receive the user input comprising purchasing information and control the network input and the non-volatile random-access storage system to receive the one or more musical pieces and store the one or more musical pieces on the non-volatile random-access storage system.

13. The audio entertainment system of claim 1, further comprising:
a media reading system comprised in the chassis and coupled to the non-volatile random-access storage system, wherein the media reading system is operable to receive audio media, wherein the audio media comprises compressed audio information, wherein the media reading system is further operable to read at least a portion of the compressed audio information from the audio media, wherein the media reading system is further operable to transmit the compressed audio information to the non-volatile random-access storage system, wherein the non-volatile random-access storage system is further operable to receive and store the compress audio information from the media reading system.

14. The audio entertainment system of claim 1, further comprising:
a processing unit comprised in the chassis and coupled to the non-volatile random-access storage system, the at least one audio input, and the at least one audio output, wherein the processing unit comprises one or more of the decompression system and the audio entertainment control system.

15. The audio entertainment system of claim 1, further comprising:
a processing unit comprised in the chassis and coupled to the non-volatile random-access storage system, the at least one audio input, and the at least one audio output, wherein the processing unit implements one or more of the decompression system and the audio entertainment control system.

16. The audio entertainment system of claim 1,
wherein the user interface system comprises one or more user output displays comprised on the chassis for displaying information to the user.

17. The audio entertainment system of claim 1,
wherein the user interface system comprises one or more user inputs comprised on the chassis for receiving user input.

18. The audio entertainment system of claim 17, wherein said one or more user inputs comprised on the chassis comprise one or more of: buttons, knobs, touchscreen inputs, and switches.

19. The audio entertainment system of claim 1, wherein the user interface system comprises a wireless remote control device.

20. The audio entertainment system of claim 1,
wherein the user interface system comprises:
one or more user inputs comprised on the chassis for receiving user input; and
a wireless remote control device, wherein the remote control device is operable to provide user input to the user interface control system.

21. The audio entertainment system of claim 1, further comprising:
a computer;
wherein the at least one audio input includes an input/output connector adapted for coupling to the computer, wherein the input/output connector is adapted to generate and/or receive control information with the computer;
wherein the computer is operable to present a user interface which is useable in controlling the user interface control system.

22. The audio entertainment system of claim 1, wherein the non-volatile random-access storage system is operable to store a contents directory which identifies locations of said plurality of musical pieces;
wherein the user interface control system uses the contents directory to selectively access ones of the plurality of compressed musical pieces.

23. The audio entertainment system of claim 1, wherein the non-volatile random-access storage system is operable to store one or more play lists, wherein each of the one or more play lists identifies locations of at least a subset of the plurality of compressed musical pieces.

24. The audio entertainment system of claim 1, wherein the user interface system is operable to receive voice commands from a user to select one or more compressed musical pieces.

25. The audio entertainment system of claim 1, wherein in a first mode the audio entertainment system is operable to continuously store previously received audio input, wherein the user interface system is operable to receive user input to select at least a portion of said previously received and stored audio input.

26. A system, comprising:
a chassis for housing electrical components;
a processor comprised in the chassis;
a non-volatile random-access storage system coupled to the processor and comprised in the chassis, wherein the non-volatile random-access storage system is substantially permanently affixed inside the chassis and is not readily removable from the chassis;
at least one audio output coupled to the processor and comprised in or located on the chassis, wherein the at least one audio output is operable to generate signals;
a network interface coupled to the processor and operable to be coupled to a network;
a memory medium comprised in the chassis and coupled to the processor, wherein the memory medium stores program instructions executable by the processor to:
receive compressed audio information from the network;
store the compressed audio information in the non-volatile random-access storage system;
access the compressed audio information from the non-volatile random-access storage system;
uncompress the compressed audio information, thereby generating uncompressed audio information; and
output the uncompressed audio information through the at least one audio output; and
a user interface system for controlling the system, wherein the user interface system comprises a display which is operable to display status information of the system and information regarding the compressed audio information stored in the non-volatile random-access storage system;
wherein the system has an appearance which approximates standard audio equipment.

27. The system of claim 26,
wherein, before said receiving compressed audio information from the network, the program instructions are further executable by the processor to:
receive user input from a user, wherein the user input indicates a selection of the compressed audio information; and
transmit the selection to the network.

28. The system of claim 27, further comprising:
a remote user input device coupled to the processor and operable by the user;
wherein, in said receiving the user input, the program instructions are further executable by the processor to receive the user input via the remote user input device.

29. The system of claim 27, wherein the user input comprises a voice command.

30. The system of claim 26,
wherein, before said uncompressing the compressed audio information, the program instructions are further executable by the processor to:
receive user input from a user, wherein the user input indicates a selection of the compressed audio information; and
wherein the program instructions are further executable by the processor to:
perform said outputting the uncompressed audio information through the at least one audio output in response to the selection.

31. The system of claim 30, further comprising:
a remote user input device coupled to the processor and operable by the user;
wherein, in said receiving the user input, the program instructions are further executable by the processor to receive the user input via the remote user input device.

32. The system of claim 31, wherein the program instructions are further executable by the processor to:
access the compressed input audio information from the non-volatile random-access storage system;
uncompress the compressed input audio information, thereby generating uncompressed input audio information; and
output the uncompressed input audio information through the at least one audio output.

33. The system of claim 26, wherein the non-volatile random-access storage system is rewritable.

34. The system of claim 26, further comprising:
one or more audio inputs comprised in or located on the chassis for receiving input audio information;
wherein the program instructions are further executable by the processor to:
receive the input audio information;
compress the input audio information, thereby generating compressed input audio information;
store the compressed input audio information in the non-volatile random-access storage system.

35. The system of claim 26, wherein the network comprises the Internet.

36. The system of claim 26, wherein the user interface system includes a display positioned on a front side of the chassis.

37. A system, comprising:
a chassis for housing electrical components;
a processor comprised in the chassis;
a non-volatile random-access storage system coupled to the processor and comprised in the chassis, wherein the non-volatile random-access storage system is substantially permanently affixed inside the chassis and is not readily removable from the chassis;
at least one audio output coupled to the processor and comprised in or located on the chassis, wherein the at least one audio output is operable to generate signals;
a receiver coupled to the processor and operable to receive a carrier wave, wherein the carrier wave comprises digital audio information;
a memory medium comprised in the chassis and coupled to the processor, wherein the memory medium stores program instructions executable by the processor to:
receive the digital audio information from the receiver;
store the digital audio information in the non-volatile random-access storage system;
access the digital audio information from the non-volatile random-access storage system;
transform the digital audio information into analog audio information; and
output the analog audio information through the at least one audio output; and
a user interface system for controlling the system, wherein the user interface system comprises a display which is operable to display status information of the system and information regarding the digital audio information stored in the non-volatile random-access storage system, wherein the user interface system is further operable to receive user input to select at least a portion of previously received and stored digital audio information;
wherein the system has an appearance which approximates standard audio equipment.

38. The system of claim 37, wherein the digital audio information comprises compressed audio information;
wherein, in said transforming the digital audio information into analog audio information, the program instruction are further executable by the processor to uncompress the compressed audio information.

39. The system of claim 37,
wherein the program instruction are further executable by the processor to compress the digital audio information from the receiver, thereby producing compressed audio information;
wherein, in said storing the digital audio information in the non-volatile random-access storage system, the program instruction are further executable by the processor to store the compressed audio information in the non-volatile random-access storage system;
wherein, in said transforming the digital audio information into analog audio information, the program instruction are further executable by the processor to uncompress the compressed audio information.

40. A system, comprising:
a chassis for housing electrical components;
a processor comprised in the chassis;
a non-volatile random-access storage system coupled to the processor and comprised in the chassis, wherein the non-volatile random-access storage system is substantially permanently affixed inside the chassis and is not readily removable from the chassis;
at least one audio output coupled to the processor and comprised in or located on the chassis, wherein the at least one audio output is operable to generate signals;
a network interface coupled to the processor and operable to be coupled to a network;
a memory medium comprised in the chassis and coupled to the processor, wherein the memory medium stores program instructions executable by the processor to:
receive audio information from the network, wherein the audio information comprises a MPEG codec;
store the audio information in the non-volatile random-access storage system;
access the audio information from the non-volatile random-access storage system;
decode the audio information, thereby producing analog audio information; and
output the analog audio information through the at least one audio output; and
a user interface system for controlling the system, wherein the user interface system comprises a display which is operable to display status information of the system and information regarding the audio information stored in the non-volatile random-access storage system;
wherein the system has an appearance which approximates standard audio equipment.

41. The system of claim 40,
wherein, before said decoding the audio information, the program instructions are further executable by the processor to:
receive user input from a user through the user interface system, wherein the user input indicates a selection of the audio information; and
wherein the program instructions are further executable by the processor to:
perform said outputting the analog audio information through the at least one audio output in response to the selection.
